(19) United States
(12) Patent Application Publication
(10) Pub. No.: US 2024/0328982 A1
(43) Pub. Date: Oct. 3, 2024

(54) END-OF-ARM TOOL FOR PERFORMING IN-PROCESS CONDUCTIVITY TESTING

(71) Applicant: PRISM Plastics, Inc., Chesterfield, MI (US)

(72) Inventors: Michael Ford Gonzalez, New Baltimore, MI (US); Patrick William Solgot, Clay, MI (US); Brian Armando Diaz, Birmingham, MI (US); Brandon Leigh Hough, Meadville, PA (US)

(73) Assignee: PRISM Plastics, Inc., Chesterfield, MI (US)

(21) Appl. No.: 18/615,798

(22) Filed: Mar. 25, 2024

Related U.S. Application Data
(60) Provisional application No. 63/493,724, filed on Mar. 31, 2023.

(51) Int. Cl. G01N 27/20; B25J 15/00; G01N 27/04

(52) U.S. Cl. CPC G01N 27/20; B25J 15/0019; G01N 27/041

(57) ABSTRACT

An inspection assembly, a system, and a method of in-process conductivity testing includes a mechanical end effector with first and second contact pads. The mechanical end effector is configured to move the first and second contact pads into contact with a manufactured part. An electrical potential is applied across the first and second contact pads. A conductivity of the manufactured part is evaluated and a dispositive action determined.

### CROSS-REFERENCE TO RELATED APPLICATIONS

The present application claims priority of U.S. Provisional Patent Application No. 63/493,724, filed on Mar. 31, 2023, the contents of which is hereby incorporated by reference in its entirety.

### BACKGROUND

In a manufacturing process, the inclusion of a single defective component can render the entire product faulty and unusable. For the same reasons, in large-scale manufacturing processes, if there are defects in a mass-produced component, each product that includes that component will be defective and must be discarded. This can be incredibly costly in terms of both goods and time. Many products include conductive materials or components that must be conductive. However, there is not a technique for testing the conductivity of components during an automated manufacturing process. As such, the conductivity of those components must be tested prior to being assembled or included in a further automated manufacturing process or once the product is complete. This places significant restrictions on the ability of a manufacturing facility to fully automate a process in which conductive components are both produced and incorporated within a larger product. Accordingly, there is a need to provide a mechanism to test the conductivity of components in real-time during an automated manufacturing process and discard components that do not satisfy applicable standards.

### BRIEF DISCLOSURE

This document discloses a system, a method for performing in-process conductivity testing of components. The testing occurs during an automated manufacturing process. The system includes a robotic arm. The robotic arm has an end-of-arm tool. The end-of-arm tool has a plurality of probes. The probes can contact a component and measure its electrical resistance. The system also includes a controller. The controller can receive the resistance measurement from the end-of-arm tool. The controller can compare the resistance measurement with a predetermined threshold. The controller can instruct the robotic arm to discard the component if the resistance measurement exceeds the threshold. The controller can also instruct the robotic arm to continue the manufacturing process if the resistance measurement does not exceed the threshold.

The method involves providing a robotic arm. The robotic arm has an end-of-arm tool. The end-of-arm tool has a plurality of probes. The method also involves contacting a component with the probes. The method further involves measuring the electrical resistance of the component. The method additionally involves comparing the resistance measurement with a predetermined threshold. The method involves discarding the component if the resistance measurement exceeds the threshold. The method also involves continuing the manufacturing process if the resistance measurement does not exceed the threshold.

An example of an inspection assembly for in-process conductivity testing of a manufactured part includes a mechanical end effector. The mechanical end effector includes first and second opposed finger blocks. The mechanical end effector is operable to move the first and second opposed finger blocks between an open position and a closed position. A first contact pad is movable with the first finger block. A second contact pad is movable with the second finger block. A first terminal is conductively connected to the second contact pad. A second terminal is conductively connected to the second contact pad. The first terminal and the second terminal are configured to be connected to a controller. The first terminal is configured to receive an electrical potential and the second terminal is configured to be monitored by the controller to determine a conductivity between the first contact pad and the second contact pad.

In examples of the inspection assembly, the mechanical end effector is configured to receive the manufactured part between the first contact pad and the second contact pad. In the closed position the first and second contact pads are in electrical communication with the manufactured part. The first contact pad and the second contact pad respectively include contact profiles, the contact profiles configured to promote the electrical communication between the first and second contact pads and the manufactured part. The conductivity between the first contact pad and the second contact pad is a conductivity of the manufactured part. The first finger block includes a first support portion and the first contact pad is connected to the first support portion. The second finger block includes a second support portion and the second contact pad is connected to the second support portion. The first and second support portions are insulative. The first contact pad extends proud of an interior surface of the first finger block. The second contact pad extends proud of an interior surface of the second finger block. The first contact pad is adjustable relative to the interior surface of the first finger block. The second contact pad is adjustable relative to the interior surface of the second finger block. The first contact pad extends through the first support portion and is connected to the first terminal and the second contact pad extends through the second support portion and is connected to the second terminal.

A system for in-process conductivity testing of a manufactured part includes a robotic arm. An end-of-arm tool (EOAT) includes an inspection assembly. The inspection assembly includes a mechanical end effector configured to move opposed first and second finger blocks between open and closed positions. The first finger block includes a first contact pad and a first terminal conductively connected to the first contact pad. The second finger block includes a second contact pad and a second terminal conductively connected to the second contact pad. A controller is communicatively connected to the inspection assembly. The controller is configured to provide an electrical potential to the first terminal and configured to monitor the second terminal to determine a conductivity between the first contact pad and the second contact pad and to made a dispositive determination regarding the manufactured part based upon the conductivity.

In examples of the system, the controller is configured to compare the conductivity to a threshold conductivity value. The controller is configured to make a binary determination of an open circuit or a closed circuit between the first and second contact pads. The manufactured part includes a plurality of parts connected by a runner and the first contact pad and the second contact pad are configured to contact the runner. A plurality of end effectors are configured to grasp the plurality of parts. A support block is positioned relative to the mechanical end effector and configured to align the runner between the first finger block and the second finger block of the mechanical end effector. The first finger block includes a first support portion and the first contact pad comprises a first contact profile configured for electrical communication with the manufactured part and the first contact pad is connected to the first support portion. The second finger block includes a second support portion and the second contact pad comprises a second contact profile configured for electrical communication with the manufactured part and the second contact pad and is connected to the second support portion. The first and second support portions are insulative.

The manufactured part is exemplarily an injection molded part and the controller is configured to operate the robotic arm and the EOAT to move the EOAT relative to an injection molding manufacturing machine to remove the manufactured part from the manufacturing machine and deliver the manufactured part to a collection receptacle or a reprocessing receptacle based upon the dispositive determination. The robotic arm is configured to move along at least one gantry between the manufacturing machine, the collection receptacle, and the reprocess receptacle. The controller is configured to evaluate manufacturing benchmarks based upon one or more signals from the manufacturing machine in parallel to the determination of the conductivity and the dispositive determination further comprises the evaluation of the manufacturing benchmarks. The mechanical end effector is configured to provide a signal to the controller and the controller is configured to make a determination if the manufactured part is between the first finger block and the second finger block when the mechanical end effector is in the closed position.

A method of in-process conductivity testing of an injection molded manufactured part includes operating a robotic arm and an end of arm tool (EOAT) to remove the part from an injection molding machine. A mechanical end effector of the EOAT is operated to move a first contact pad and a second contact pad into physical contact with a runner of the injection molded manufactured part. The part is moved relative to the injection molding machine with the robotic arm and the EOAT. An electrical potential is provided between the first contact pad and the second contact pad across the runner. A conductivity of the runner between the first contact pad and the second contact pad is evaluated. A dispositive determination is made regarding the injection molded manufactured part based upon the conductivity.

### BRIEF DESCRIPTION OF THE DRAWINGS

The drawings illustrate and disclose by way of example and are not limiting on the scope of the present disclosure.

FIG. 1 depicts an example of a robotic arm in a manufacturing process.

FIG. 2 is a perspective view of an example end-of-arm tool and inspection assembly for performing in-process conductivity testing, according to one or more aspects described herein.

FIG. 3 a perspective view of another example of an end-of-arm tool and inspection assembly for performing in-process conductivity testing.

FIG. 4 is an additional perspective view of the end-of-arm tool and inspection assembly.

FIG. 5 is detailed top view of the inspection assembly.

FIG. 6 is a flow diagram of an example method for using an end-of-arm tool to perform in-process conductivity testing.

These drawings are provided for purposes of illustration only and merely depict typical or example embodiments. These drawings are provided to facilitate the reader's understanding and shall not be considered limiting of the breadth, scope, or applicability of the disclosure. For clarity and ease of illustration, these drawings are not necessarily drawn to scale.

### DETAILED DISCLOSURE

In the following description of various examples of the invention, reference is made to the accompanying drawings, which form a part hereof, and in which are shown by way of illustration various example structures, systems, and steps in which aspects of the invention may be practiced. It is to be understood that other specific arrangements of parts, structures, example devices, systems, and steps may be utilized, and structural and functional modifications may be made without departing from the scope of the present invention. Also, while the terms “top,” “bottom,” “front,” “back,” “side,” and the like may be used in this specification to describe various example features and elements of the invention, these terms are used herein as a matter of convenience, e.g., based on the example orientations shown in the figures. Nothing in this specification should be construed as requiring a specific three-dimensional orientation of structures in order to fall within the scope of this invention.

The present disclosure relates to an end-of-arm tool for performing in-process conductivity testing. As described herein, an “end-of-arm tool” generally refers to a device at the end of a robotic or remotely-controllable arm that is designed to interact with objects or an environment within a specified vicinity of the robotic or remotely-controllable arm. For example, an end-of-arm tool may be configured to grab, manipulate, evaluate, and/or otherwise interact with object(s) or an environment surrounding the arm. The nature of the interaction by the device depends on the configuration and application of the end-of-arm tool and/or the robotic arm itself.

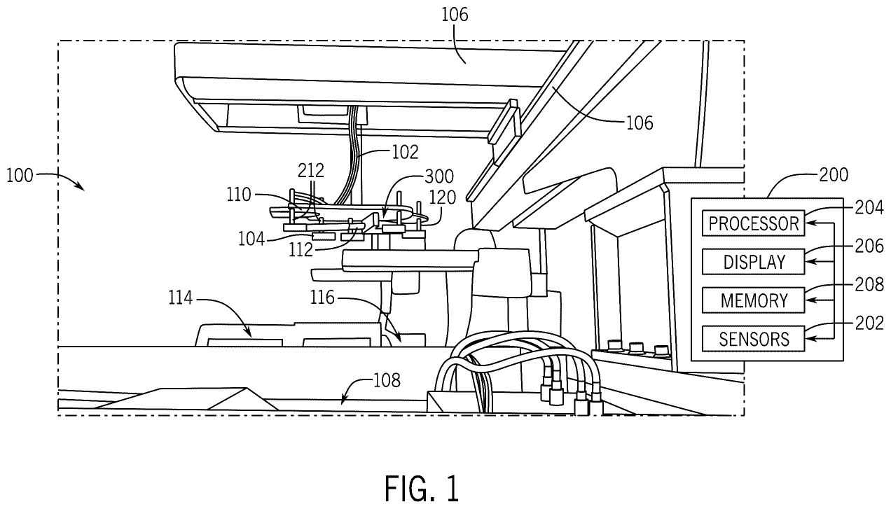

FIG. 1 depicts an example of a system 100 for manufacturing with in-process conductivity testing. The system 100 includes a robotic arm 102 used as described herein to manipulate a part 104 in a manufacturing process. In a non-limiting example, the manufacturing process is an injection molding process. The robotic arm 102 is movable on a gantry 106 extending over a manufacturing environment. It is recognized that more than one gantry may be used in other examples. A manufacturing machine 108, which is exemplarily any of a variety of injection molding machines, for example, for thermoplastic resin, thermoset polymers, metal injection molding (MIM) compounds, or other materials as may be recognized by a person of ordinary skill in the art based upon the present disclosure. In other non-limiting examples, the manufacturing machine may be an extruder, caster, or 3d printer. The robotic arm 102 is operated by a controller 200 to remove the formed part 104, or plurality of parts as described herein, from the manufacturing machine 108 using an end-of-arm tool (EOAT) 110. The robotic arm 102 and the end of arm tool 110 move the part 104 to take dispositive action with the part 104.

In an example, injection molded parts may have specifications or requirements for conductivity or non-conductivity. In an example, an exemplary base thermoplastic material, for example polyethylene (PE), polypropylene (PP), polyamide (PA), polytetrafluoroethylene (PTFE), or others may be used in injection molding processes. These materials are generally insulative and non-conductive, but when doped with a conductive material like graphite, carbon, or iron are made conductive. One non-limiting use for conductive parts are for fuel lines, connectors, or valves, for example, those used in the automotive industry. The conductive parts are grounded to discharge any build up of static electricity to prevent static arcing in the presence of combustible substances.

In injection molding, one or more runners 112 of the molding material connect the injection unit to the cavity forming the part. Efficiencies of time and material can be gained by molding a plurality of parts with one shot of the molding machine. To do so, multiple runners may direct the molten material to the cavities, to produce parts in each of the cavities of the mold with each shot of the machine. The EOAT 110 and robotic arm 102 operate to remove the part(s) 104 from the machine 108. The EOAT 110 includes one or more end effectors 120, which are exemplarily stanchions with distal suction cups and operably connected to a source of negative pressure. When the EOAT 110 is positioned within the machine 108 to extract the part(s) 104, the controller 200 operates to initiate the negative pressure at the end effectors 120 to secure the part(s) 104 or portions thereof to the end effector 120. In the example of the negative pressure effectors, the pressure at each effector is monitored by the controller 200 to make a determination if the part 104 has been successfully secured, which would occlude the suction cup with a commensurate change in pressure compared to the ambient. It will be recognized based upon the present disclosure that other forms of end effectors 120 may be used while remaining within the scope of the present disclosure.

The controller 200 is exemplarily a human-machine-interface (HMI) that includes the software and hardware that allows a human operator to monitor the state of the manufacturing process under control, and if needed, manually intervene in the event of an error or emergency. The controller 200 exemplarily implements the conductivity sensor 202, receiving and monitoring a signal from the output side of the terminals 350, as described herein. The controller includes a processor 204, a display 206, and a memory 208. In examples, the processor 204 may be any suitable hardware processor or combination of processors, such as a central processing unit (CPU), a graphics processing unit (GPU), an accelerated processing unit (APU), a microcontroller, an application specific integrated circuit (ASIC), a field-programmable gate array (FPGA), etc. The controller exemplarily includes other sensors, including pressure sensors, current sensor, force sensors, or receives signal from such sensors to carry out the HMI operations and the conductivity testing as described herein.

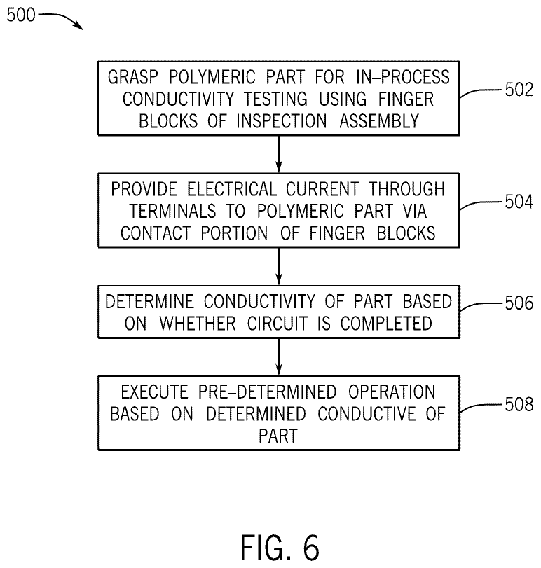

The memory 208 can include any suitable storage device or devices that can be used to store instructions, values, etc. that can be used, for example, by the processor 204 to generate, receive, analyze, or present (e.g. with display 206) data. The memory 208 can include any suitable volatile memory, non-volatile memory, storage, or any suitable combination thereof. For example, memory 208 can include random access memory (RAM), read-only memory (ROM), electronically-erasable programmable read-only memory (EEPROM), one or more flash drives, one or more hard disks, one or more solid state drives, one or more optical drives, etc. In some examples, memory 208 can have encoded thereon a computer program for execution by the processor 204 to send control signals for operation of the robotic arm 102 and EOAT 110 as described herein. In further examples, the computer program for execution by the processor 204 may cause the controller 200 to carry out some or all of the processes or functions as described herein, including some or all of the process 500 described below with respect to FIG. 6.

The controller 200 is programmed to evaluate each cycle of the manufacturing process to confirm that manufacturing benchmarks were achieved during the one shot injection. Such benchmarks may include measured temperatures, pressures, material volume, etc. which are deemed indicative of a completed one shot molding. Based upon this benchmark evaluation, the controller 200 operates the robotic arm 102 and the EOAT 110 to take a dispositive action with the molded part(s) 104. If the benchmark evaluation is passed, the robotic arm 102 and EOAT 110 are operated to deposit the part(s) 104 in a part collection receptacle 114. Any runners or remaining material may be deposited in a reprocessing receptacle 116 for disposal or grinding for reuse. If one or more manufacturing benchmarks are not achieved, the part(s) 104 are rejected and the robotic arm 102 and the end-of-arm tool 110 operated to deposit them in the reprocessing receptacle 116.

An inspection assembly 300 is disclosed herein which is incorporated into an end-of-arm tool 110 for in-process conductivity testing of parts 104, for example, injection molded parts. Given a relative homogeneity of the molded material, a testing economy is achieved by testing the conductivity of the plurality of interconnected parts 104 as the parts 104 are removed from the machine 108. In an example, the inspection assembly is configured for physical engagement with a part 104, or more specifically a runner 112 serving one or more parts 104 molded in a single shot operation.

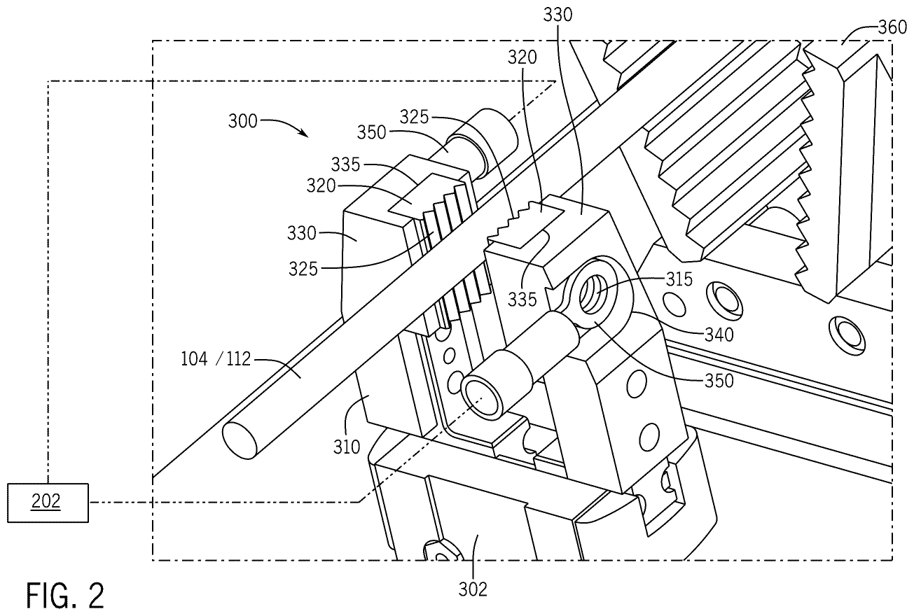

FIG. 2 is a detailed perspective view of an inspection assembly 300 on an EOAT 110 for performing in-process conductivity testing, according to one or more aspects described herein. In various embodiments, the inspection assembly 300 of EOAT 110 may be configured to identify defective parts in-process by testing the conductivity of the parts in-process. Accordingly, the inspection assembly 300 of the EOAT 110 may function as a quality control system. As described in further detail herein, in various embodiments, the EOAT 110 may subsequently be operated to carry out action to automatically remove defective parts. In various embodiments, the inspection assembly 300 may include a conductivity sensor 202, which may be implemented in whole or in part with controller 200, an end effector 302, and/or one or more other components. In various embodiments, conductivity sensor 202 may be configured to determine whether a part 104 (e.g including runner 112 of part 104) closes a circuit when electrical current (e.g., 24V) is provided between contact pads 320 placed in concurrent contact with the part 104 by a mechanical end effector 302.

Examples of end effectors 302 are described herein which include mechanical force and/or movement of the conductive contact pads 320 into contact with the part 104, or otherwise to secure, surround, or grasp the part 104 in conductive contact. A person of ordinary skill in the art will recognize from the present disclosure that other forms of end effectors may be used while remaining within the scope of the present disclosure including, but not limited to suction or magnetic force to secure, grasp, or otherwise position an object. By way of non-limiting examples, end effectors may further include one or more conductivity cups, electromagnets, Bernoulli grippers, electrostatic grippers, van der Waals grippers, capillary grippers, cryogenic grippers, ultrasonic grippers, laser grippers, and/or other components configured to grasp and/or secure an object.

In various embodiments, end effector 302 may include finger blocks 310. The finger blocks 310 include the contact pad 320 and a support portion 330. The finger blocks 310 are configured to move between open and closed positions, changing the relative distance and spacing between the finger blocks 310 and/or at least the contact pads 320 of the finger blocks 310. In examples, the mechanical force or motion carried out by the end effector 302 may include translation or pivot of the finger blocks 310. In some examples, translative movement of the finger blocks 310 may be preferred as an even distance between the contact pads 320 can be maintained, which reduces any risk of inadvertent conductive contact between the contact pads 320 creating a short circuit around the part to be tested. The finger blocks 310 may exemplarily be moved along a rail or rack by electrical or pneumatic force. The finger blocks 310 each include a contact pad 320, the contact portion at least partially surrounded by, encompassed within, or otherwise incorporated with a support portion 330. In some embodiments, contact pad 320 may be adjacent to or otherwise positioned to one side of the support portion 330, but not surrounded by support portion 330. The contact pad 320 exemplarily extends proud of an interior surface 345 of the support portion 330. By extending interiorly towards each other the contact pads 320 promote engagement of the contact pads with the part 104/runner 112.

In examples, the contact pad 320 is mechanically secured to the support portion 330, this may exemplarily be by friction fit, threads, threaded fasteners, adhesive, epoxy, or other forms of securement. The contact pad 320 and the support portion 330 may have keyed corresponding shapes to further promote a mechanical connection between the components of the finger blocks 310. The contact pads 320 are constructed of a conductive material, for example, metal or include metal. In an example, the contact pad 320 is constructed of stainless steel. The support portion 330 is exemplarily constructed of an insulative material, for example, but not limited to nylon, so as to electrically isolate the contact pads 320 and avoid shorts between the contact pads 320. The contact pad 320 may further include a contact profile 325. The contact profile 325 may include ribs, ridges, teeth, pins, projection, or other surface features selected for the purpose of promoting a conductive contact between the contact pad 320 and the part 104 or runner 112. In an example, wherein the end effector 302 is configured to place the contact pads 320 in contact with the runner 112, marring or blemishing of the runner 112 may be acceptable to promote conductive contact to a degree which would not be acceptable if the contact pads 320 engaged a part 104 itself.

The support portion 330 may include one or more access openings 340 through which conductivity sensor 202 is electrically connected to the contact pad 320. In various embodiments, a terminal 350 (including, but not limited to, a ring terminal) may be attached to access opening 340 of support portion 330 in each finger block 310. The access opening 340 exposes or partially exposes an exterior side 335 of the contact pad 320 for electrical connection to the terminal 350. The exterior side 335 is exemplarily opposite the contact profile 325 and in examples, may be embedded within the support portion 330. In examples, the exterior side 335 of the contact pad 320 may be exposed in the access opening 340 and the terminal 350 is soldered or epoxied in contact with the contact pad 320. In the example depicted, a threaded bore 315 extends from the access opening 340 through the support portion 330 to the exterior side 335 of the contact pad 320. A threaded fastener (not depicted) through the threaded bore 314 exemplarily secures the terminal 350 to the support portion 330 and provides the electrical connection between the terminal 350 and the contact pad 320. The terminals 350 on opposed finger blocks 310 of the end effector 302 are connected to the conductivity sensor 202.

In a manufacturing process, the robotic arm 102 and the EOAT 110 are communicatively connected to, and operated by, the controller 200. In the manufacturing process, for example the injection molding of conductive polymeric part(s) 104, the controller 200 operates the robotic arm 102 and the EOAT 110 to remove the molded polymeric part(s) 104. As previously noted, the end effectors 120 are configured to grasp one or more polymeric part(s) as molded in a single shot of the mold. The end effectors 120 are exemplarily use negative pressure to releasably secure to the part 104. Pressure sensors connected to end effectors 120 provide a signal to the controller 200 indicative that the end effector 120 has grasped a part 104. The robotic arm 102 and the EOAT 110 are manipulated to remove the part 104 from the machine 108 and move the part 104 to a dispositive location (e.g. the collection receptacle 114 or reprocessing receptacle 116). As noted above, during this time, the controller 200 in operation as an HMI, evaluates the completed manufacturing process to confirm that manufacturing benchmarks such as temperature, pressure, material volume, were achieved during the one shot injection molding process, and determines the dispositive location for the part 104.

In addition, before the dispositive determination is made, the processor 204 is further operable to complete the analysis of the process 500 as depicted in the flow chart of FIG. 6. It is recognized that the operations of process 500 presented below are intended to be illustrative and, as such, should not be viewed as limiting. In some implementations, process 500 may be accomplished with one or more additional operations not described, and/or without one or more of the operations discussed. In some implementations, two or more of the operations of process 500 may occur substantially simultaneously. The described operations may be accomplished using some or all of the system components described in detail above.

In an operation 502, while the end effector(s) 120 grasp the part(s) 104, the inspection assembly 300 operates to grasp the part(s) 104, and exemplarily a runner 112 of the molded part(s) 104, for conductivity testing. The inspection assembly 300 includes a mechanical end effector which places the opposed contact pads 320 into conductive contact with the part(s) 104. A tension or force sensor, associated with the mechanical end effector 302 communicates to the controller 200, exemplarily operating in the capacity of the HMI, an indication that the mechanical end effector 302 has gasped an object between the contact pads 320 of the finger blocks 310. This indication may provide that the finger blocks 310 are under load, but are not in a position for the contact pads 320 to touch, thereby shorting the testing circuit as described herein.

Next, at 504, an electrical potential is applied across the contact pads 320. In an example a 24 volt potential is differentially applied between terminals 350 in respective conduction with the contact pads 320. It will be recognized by a person of ordinary skill in the art that this potential or any of a variety of voltage potentials may be used and any of a variety of ranges of currents may be used as available to the system and suitable for the application and part to be tested.

At 506, the conductivity of the part is determined by the controller 200 based on whether a circuit is completed through the part between the contact pads 320. The spacing of the contact pads 320 creates an open circuit. If the material of the part grasped by the end effector 302 between the contact pads 320 is conductive, a current will flow between contact pads 320 completing the circuit. In one example, the testing criteria is a binary determination of a closed circuit or open circuit. In still further examples, the testing criteria is a threshold of a particular current through the part 104 or resistance of the part 104 as the part specification may be specified. Based on whether, and the manner in which, the part closes the circuit, the end-of-arm tool may be configured to determine the conductivity of the part.

With the conductivity of the part determined, the conductivity evaluation is considered at 508 by the controller 200 in the capacity of HMI along with the other manufacturing process benchmarks. As with other benchmarks, if the conductivity specification is met, the robotic arm 102 and the EOAT 110 are operated to move the part(s) 104 to the collection receptacle. If the conductivity specification is not met, the robotic arm 102 and the EOAT 110 are operated to reject the part(s) 104 and deposit the part(s) 104 in the reprocessing receptacle 116. The controller 200 operating in the capacity as the HMI may further operate to produce an error message or warning regarding failure of the part(s) 104 to meet the conductivity specification and produce an audible and/or visual alert to a human operator. In a still further example, if the conductivity specification is not met, the robotic arm 102 and the EOAT 110 may be operated to deposit the segregated receptacle so that the material of the rejected part(s) may be evaluated.

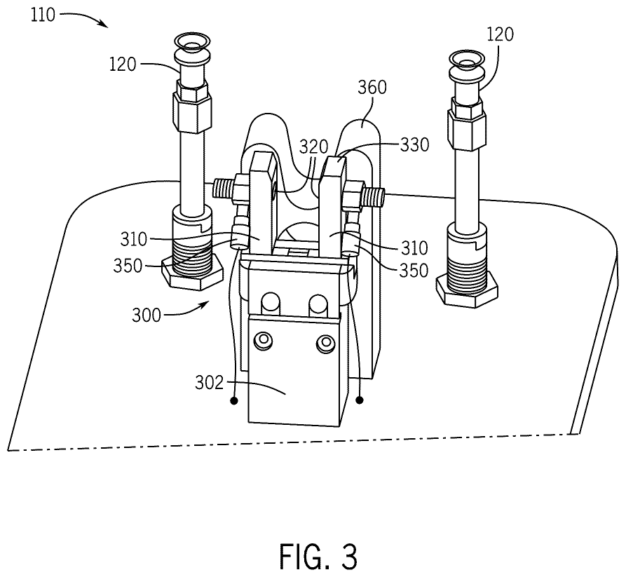

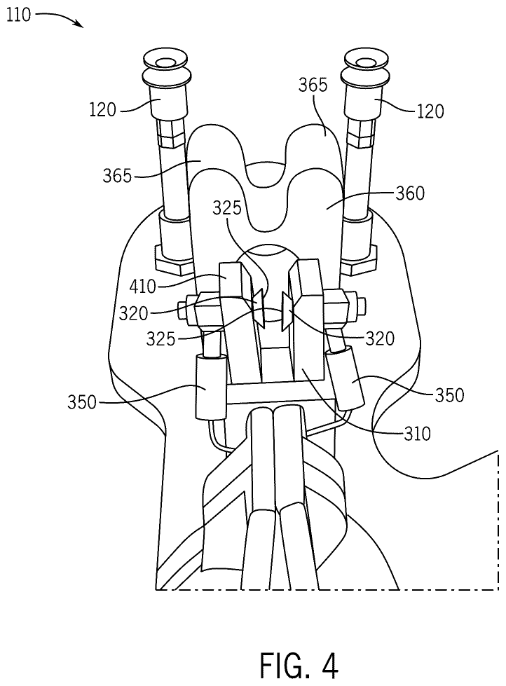

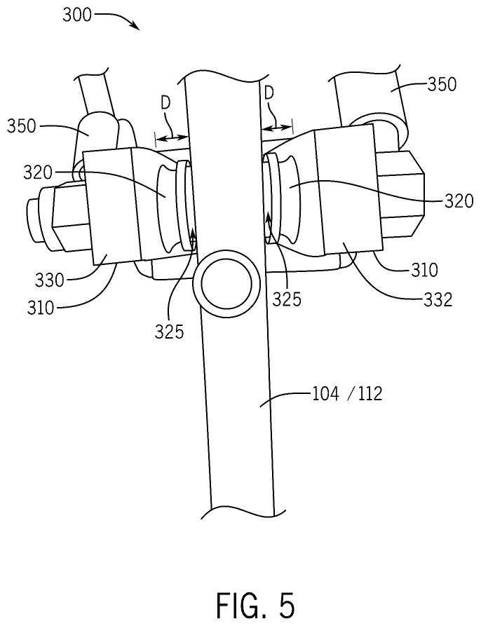

FIGS. 3-5 depict views of an additional example of the EOAT 110 and the inspection assembly 300. It will be recognized that like reference numerals are used to reference like components between the examples, and that features described between examples may be used or recombined to form additional examples, while remaining within the present disclosure. FIGS. 3 and 4 are perspective views of the EOAT 110 and the inspection assembly 300 and FIG. 5 is a detailed top view of the inspection assembly 300. The EOAT 110 additionally includes a support block 360. The support block 360 is exemplarily constructed of nylon or another insulative material, for example a non-conductive rubber or polymer. The support block 360 is arranged in proximity to the inspection assembly 300, an in particular to the end effector 302 of the inspection assembly 300. The support block 360 exemplarily includes support projections 365 which define a tapering channel which is configured to help align the part(s) 104/runner 112 between the finger blocks 310 of the inspection assembly 300. The support block 360 thereby helps to perform a rough alignment. The support block 360 contacts the part(s) 104 or the runner 112 of the part(s) and positions the same between the contact pads 320.

In this example, and as best depicted with respect to FIG. 5, the contact pads 320 extend through the support portion 330 and are directly connected to the terminals 350. Additionally, as the contact pads 320 extend through the support portion 330, the contact pads 320 are adjustable to determine a distance D that the contact profile 325 of the contact pad 320 extends proud of the interior surface of the support portion 330.

In the above description, certain terms have been used for brevity, clarity, and understanding. No unnecessary limitations are to be inferred therefrom beyond the requirement of the prior art because such terms are used for descriptive purposes and are intended to be broadly construed. The different systems and method steps described herein may be used alone or in combination with other systems and methods. It is to be expected that various equivalents, alternatives, and modifications are possible within the scope of the appended claims.

The functional block diagrams, operational sequences, and flow diagrams provided in the Figures are representative of exemplary architectures, environments, and methodologies for performing novel aspects of the disclosure. While, for purposes of simplicity of explanation, the methodologies included herein may be in the form of a functional diagram, operational sequence, or flow diagram, and may be described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology can alternatively be represented as a series of interrelated states or events, such as in a state diagram. Moreover, not all acts illustrated in a methodology may be required for a novel implementation.

This written description uses examples to disclose the invention, including the best mode, and also to enable any person skilled in the art to make and use the invention. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. An inspection assembly for in-process conductivity testing of a manufactured part, the inspection assembly comprising:
a mechanical end effector comprising first and second opposed finger blocks, the mechanical end effector operable to move the first and second opposed finger blocks between an open position and a closed position;
a first contact pad, movable with the first finger block;
a second contact pad, movable with the second finger block;
a first terminal conductively connected to the first contact pad; and
a second terminal conductively connected to the second contact pad;
wherein the first and second terminals are configured to be connected to a controller, wherein the first terminal is configured to receive an electrical potential and the second terminal is configured to be monitored by the controller to determine a conductivity between the first contact pad and the second contact pad.

2. The inspection assembly of claim 1, wherein the mechanical end effector is configured to receive the manufactured part between the first contact pad and the second contact pad, wherein in the closed position, the first and second contact pads are in electrical communication with the manufactured part.

3. The inspection assembly of claim 2, wherein the first contact pad and the second contact pad respectively comprise contact profiles, the contact profiles configured to promote the electrical communication between the first and second contact pads and the manufactured part.

4. The inspection assembly of claim 2, wherein the conductivity between the first contact pad and the second contact pad is a conductivity of the manufactured part.

5. The inspection assembly of claim 1, wherein the first finger block comprises a first support portion wherein the first contact pad is connected to the first support portion;
wherein the second finger block comprises a second support portion wherein the second contact pad is connected to the second support portion; and
wherein the first and second support portions are insulative.

6. The inspection assembly of claim 5, wherein the first contact pad extends proud of an interior surface of the first finger block and the second contact pad extends proud of an interior surface of the second finger block.

7. The inspection assembly of claim 6, wherein the first contact pad is adjustable relative to the interior surface of the first finger block and the second contact pad is adjustable relative to the interior surface of the second finger block.

8. The inspection assembly of claim 5, wherein the first contact pad extends through the first support portion and is connected to the first terminal and the second contact pad extends through the second support portion and is connected to the second terminal.

9. A system for in-process conductivity testing of a manufactured part, the system comprising:
a robotic arm;
an end-of-arm tool (EOAT) comprising an inspection assembly, the inspection assembly comprising:
a mechanical end effector configured to move opposed first and second finger blocks between open and closed positions, the first finger block comprising a first contact pad and a first terminal conductively connected to the first contact pad and the second finger block comprising a second contact pad and a second terminal conductively connected to the second contact pad; and
a controller communicatively connected to the inspection assembly and configured to provide an electrical potential to the first terminal and configured to monitor the second terminal to determine a conductivity between the first contact pad and the second contact pad and to made a dispositive determination regarding the manufactured part based upon the conductivity.

10. The system of claim 9, wherein the controller is configured to compare the conductivity to a threshold conductivity value.

11. The system of claim 10, wherein the controller is configured to make a binary determination of an open circuit or a closed circuit between the first and second contact pads.

12. The system of claim 9, wherein the manufactured part is an injection molded part and the controller is configured to operate the robotic arm and the EOAT to move the EOAT relative to an injection molding manufacturing machine to remove the manufactured part from the manufacturing machine and deliver the manufactured part to a collection receptacle or a reprocessing receptacle based upon the dispositive determination.

13. The system of claim 12, further comprising at least one gantry, wherein the robotic arm is configured to move along the at least one gantry between the manufacturing machine, the collection receptacle, and the reprocess receptacle.

14. The system of claim 12, wherein the controller is configured to evaluate manufacturing benchmarks based upon one or more signals from the manufacturing machine in parallel to the determination of the conductivity and the dispositive determination further comprises the evaluation of the manufacturing benchmarks.

15. The system of claim 12, wherein the mechanical end effector is configured to provide a signal to the controller and the controller is configured to make a determination if the manufactured part is between the first finger block and the second finger block when the mechanical end effector is in the closed position.

16. The system of claim 9, wherein the manufactured part is an injection molded part that comprises a plurality of parts connected by a runner and the first contact pad and the second contact pad are configured to contact the runner.

17. The system of claim 16, further comprising a plurality of end effectors configured to grasp the plurality of parts.

18. The system of claim 16, further comprising a support block positioned relative to the mechanical end effector and configured to align the runner between the first finger block and the second finger block of the mechanical end effector.

19. The system of claim 9, wherein the first finger block comprises a first support portion and the first contact pad comprises a first contact profile configured for electrical communication with the manufactured part and the first contact pad is connected to the first support portion;
wherein the second finger block comprises a second support portion and the second contact pad comprises a second contact profile configured for electrical communication with the manufactured part and the second contact pad and is connected to the second support portion; and
wherein the first and second support portions are insulative.

20. A method of in-process conductivity testing of an injection molded manufactured part, the method comprising:
operating a robotic arm and an end of arm tool (EOAT) to remove the part from an injection molding machine;
operating a mechanical end effector of the EOAT to move a first contact pad and a second contact pad into physical contact with a runner of the injection molded manufactured part;
moving the part relative to the injection molding machine with the robotic arm and the EOAT;
providing an electrical potential between the first contact pad and the second contact pad across the runner;
evaluating a conductivity of the runner between the first contact pad and the second contact pad; and
making a dispositive determination regarding the injection molded manufactured part based upon the conductivity.
